(19) United States
(12) Patent Application Publication
(10) Pub. No.: US 2009/0326738 A1
(43) Pub. Date: Dec. 31, 2009

(54) DEVICE FOR AIDING TO TAKE A DECISION CONCERNING THE ABILITY OF AN AIRCRAFT TO START A FLIGHT

(75) Inventor: Daniel Ferro, Muret (FR)

Correspondence Address: Dickinson Wright PLLC;James E. Ledbetter, Esq., International Square, 1875 Eye Street, NW., Suite 1200, WASHINGTON, DC, 20006, US

(73) Assignee: AIRBUS France, Toulouse (FR)

(21) Appl. No.: 12/123,296

(22) Filed: May 19, 2008

(30) Foreign Application Priority Data
May 23, 2007 (FR) 07 03648

(51) Int. Cl. G06F 7/00

(52) U.S. Cl. 701/3

(57) ABSTRACT

The device (1) comprises means (8) for carrying out an automatic correlation between a failure state of the aircraft, determined automatically, and a minimum equipment list, recorded in a database (7), so as to be able to deduce therefrom the ability of the aircraft to start a flight.

The present invention relates to an assistance device intended to aid an operator to take a decision relating to the ability of an aircraft, in particular of a transport plane, to start a flight.

It is known that the crew of a transport plane must, before beginning a flight, determine whether the hardware conditions of the plane are adequate to perform the flight with the required safety. This is a prerogative of responsibility of the flight captain.

Accordingly, a document is available to the crew in paper form, representing a Minimum Equipment List or MEL list, which describes the minimum equipment that must be in a fit state to operate, by system categories, to perform the flight. As a function of the actual configuration of the plane (following faults, for example, or because of missing equipment), the crew applies a relatively deterministic logic, which enables them to ascertain whether the plane is able to start the flight.

Furthermore, the crew is aware of the state of the plane via various sources:
visual and/or auditory electronic sources, through partial knowledge of the failed items of equipment, which have been detected automatically;
via observation inside the cockpit (for example a cracked glass pane), or during an outside tour of inspection of the plane (for example absence of a bolt on a wheel);
sources of variable form (paper or electronic) depending on the planes, through a report made by the maintenance team, which worked on the plane before preparation for departure.

The crew can thus make a correspondence between the list of missing equipment and the list (provided by the MEL list) of the failures ruling out departure (and therefore requiring a specific maintenance operation). The judgment and experience of the flight captain intervene last to confirm or amend the deterministic analysis mentioned above.

It will be noted that the MEL list is not unique for a given type of plane. It is in fact built, in general, by the airline, on the basis of general advocacy provided by the constructor of the plane, called an MMEL list (“Master Minimum Equipment List”). The MEL list cannot be less restrictive than the MMEL list. It is therefore usually more conservative.

In the course of a given flight, the plane may be confronted with equipment faults, which are detected automatically (most frequently the case) or by the flight crew. This information is sometimes used by the flight crew to determine the risks that the following flight is impacted from the viewpoint of a plane's in-flight ability and that a maintenance operation is required. However, the fault state may evolve in the course of the flight (certain faults possibly being transient and therefore disappearing). This is the reason why the analysis mentioned above is taken into account with wholly relative confidence.

Additionally, it is increasingly frequent that the airline's operations or maintenance center, in digital communication with the plane's systems, is partially aware of the state of the plane, for example engine parameters or system faults. This fragmented state of awareness of faults can, in some cases, lead one to conclude with some confidence, that a fault presents significant risks of arising in the course of the following flight and that it is therefore sensible to envisage a maintenance operation.

The advantage of the two in-flight processes described above (aboard the plane and on the ground), is that it may in some cases lead the airline to adequately anticipate a maintenance operation, and therefore mobilize the necessary human and hardware resources with adequate notice, so as not to unduly delay the future departure of the plane.

It may also be very useful for the flight captain and/or for an operations or maintenance center of the company, to be aware, following a failure which occurs in flight, of the consequences induced by the MEL list on the ability to start the next flight, for example so as to decide on a diversion if a maintenance operation rendered indispensable by the nature of the failure requires significant installations that are not available at the initially scheduled destination.

However, on the ground before the flight, the task of the flight captain which consists in determining, following any failure, whether the flight is authorized, may be lengthy and complex, while the duration allocated to this task is, usually, necessarily reduced so as to avoid delays on takeoff.

In numerous cases, the failures signaled correspond to those listed in the MEL list. However, this is not always the case, hence the difficulty mentioned above, which leads to an overload of work and to risks of analysis error.

Additionally, once a failure has been precisely identified, the technical possibility of departure has to be determined by consulting and applying the relatively deterministic logic described in the MEL list. This logic may require the consultation of much information regarding the state of the plane, and therefore require a not-inconsiderable time duration, liable to prevent the plane taking off at the scheduled time.

Now, any delay is very penalizing for the airline, for various reasons (risk of having to wait for another, sometimes distant, takeoff slot; commercially penalizing delay on arrival, especially in the case where connections are missed).

Another, significant, problem is that sometimes the flight captain, busy at the time, may be induced to make an erroneous analysis of the situation, with the two possible consequences:
in the best case, a poor decision is taken not to perform the flight without corrective action (departure almost certainly delayed); and
in the worst case, an overestimation of the regulatory departure ability with taking of risks, either of safety (in-flight incident), or of infringing the regulation or regulations of the states overflown.

These same questions can arise during an in-flight failure. Specifically, on account:
of the requirement to ascertain in a reliable manner either the possibility of carrying out fault repairs at the scheduled destination, or the obligation to steer towards another aerodrome better equipped for maintenance; and
of the fact of performing this analysis in concomitance with the pilot's standard tasks (piloting, navigating, communicating, managing systems),
   a conflict of tasks may occur which may result either in a significant growth in the workload (which is negative in terms of impact on safety), or in an erroneous analysis, with the possible consequences of taking a non-optimal decision at the time to continue the flight or to divert.

The object of the present invention is to remedy the aforesaid drawbacks. It relates to an assistance device making it possible to aid an operator, for example a crew member of an aircraft and in particular the pilot, or even an operator on the ground, to take a decision, in a particularly reliable manner and without increasing the workload of this operator, relating to the ability of the aircraft, in particular a transport plane, to start (that is to say to begin) a flight.

For this purpose, according to the invention, said assistance device is noteworthy in that it comprises:
onboard sensors capable of automatically generating first fault information relating to equipment of the aircraft;
input means allowing an operator to input second fault information relating to equipment of the aircraft;
first means capable of automatically determining, with the aid of said first and second fault information received, a failure state which illustrates the whole set of failures of the aircraft;
a digitized database which comprises a minimum equipment list in a proper state of operation for the flight;
correlation means which carry out an automatic correlation between the failure state received from said first means and at least said minimum equipment list received from said database so as to be able to deduce therefrom the regulatory ability of the aircraft to start the flight; and
presentation means for presenting the results of said correlation to an operator.

Thus, by virtue of the invention, the correlation means carry out, before a flight, a correlation between the minimum equipment list and the failure state of the aircraft, so as to be able to deduce therefrom whether the aircraft is (or is not) in a fit state to start the flight. As this correlation and the presentation of the results of this correlation are carried out in an automatic manner, the assistance device in accordance with the invention makes it possible to greatly reduce the workload of the operator, in particular the pilot of the aircraft, in his decision taking relating to the start of the flight. Consequently, said assistance device makes it possible to remedy the aforesaid drawbacks.

Preferably, said correlation means are formed so as to be able to deduce, moreover, if appropriate:
operational limitations; and
dimensioning failures.

In a first preferred embodiment, the whole of the assistance device is onboard the aircraft and therefore aids the crew, in particular the pilot (or flight captain), in taking their decision relating to the start of the flight.

Furthermore, in a second embodiment, except for said sensors, said device forms a set which is not onboard the aircraft and which is connected to said onboard sensors by a data transmission link. In this case, this set that is not onboard is, preferably, situated on the ground, within a service of the airline which is for example provided at the departure airport level and the purpose of which may, in particular, be to decide or otherwise regarding the starting off of the aircraft.

Additionally, in an advantageous manner, said assistance device comprises, moreover, interrogation means capable of requesting an operator to input particular information into said device, especially information making it possible to characterize the nature of the envisaged flight.

Additionally, in a particular embodiment, said assistance device also comprises:
means which are triggerable by an operator and which present, when a failure is detected and they are triggered, information relating to this failure, which emanates from said minimum equipment list, thereby making it possible to aid the pilot to acquire all the information necessary to comprehend an ongoing situation and take his decision to depart or not; and/or
means for establishing a synthetic state, when several failures arise, thereby allowing the operator to have a global and synthetic picture of the actual situation of the aircraft.

Additionally, in a particular embodiment, which is at least in part implemented in the course of a flight and which is intended for decision taking pertaining to the starting off of the aircraft relating to the following flight:
said device comprises moreover:
   onboard auxiliary sensors capable of automatically generating, during the flight, fault information relating to equipment of the aircraft; and
   second means capable of automatically determining, with the aid of the fault information received from said auxiliary sensors, an auxiliary failure state which indicates anticipated failures; and
said correlation means carry out an automatic correlation between the auxiliary failure state received from said second means and said minimum equipment list received from said database so as to be able to deduce therefrom if appropriate:
   a the ability or otherwise of the aircraft to start the next flight;
   operational limitations; and
   dimensioning failures; and
said presentation means present the results of this correlation to an operator.

The figures of the appended drawing will clearly elucidate the manner in which the invention may be carried out. In these figures, identical references designate similar elements.

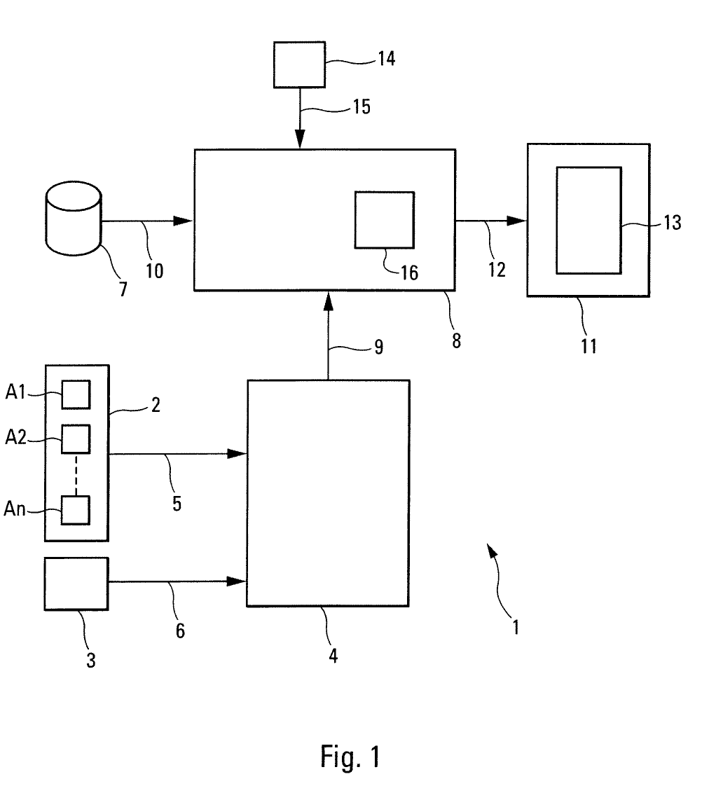

FIG. 1 is the schematic diagram of an assistance device in accordance with the invention.

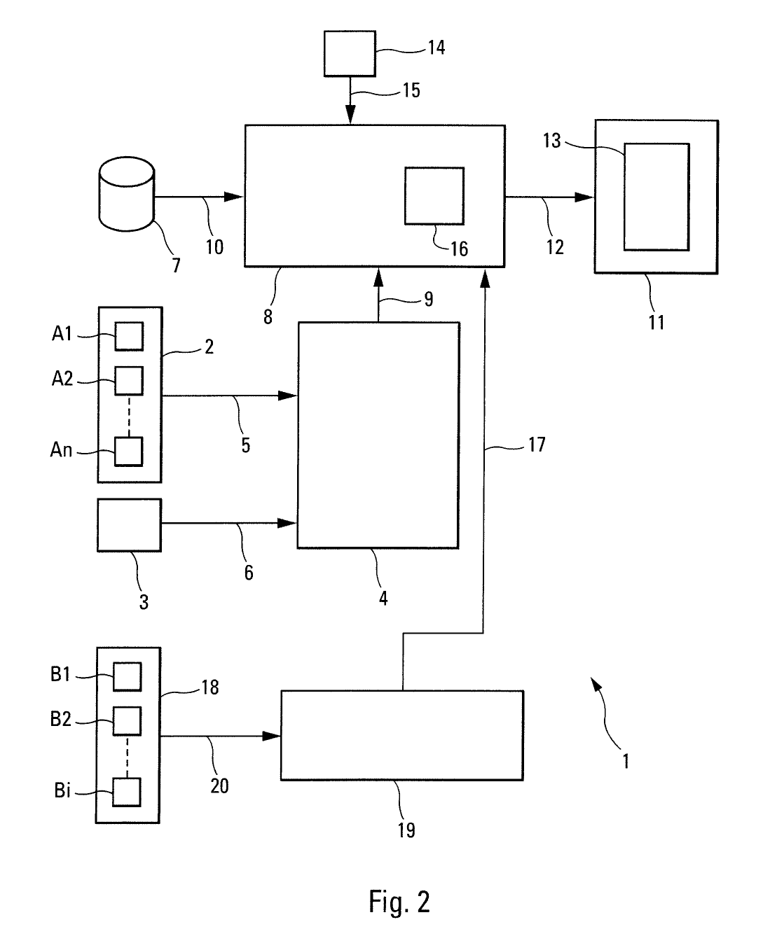

FIG. 2 is the schematic diagram of a particular embodiment of an assistance device in accordance with the invention, intended for decision taking relating to the ability of an aircraft to start the next flight.

The device 1 in accordance with the invention and schematically represented in FIG. 1 is intended to assist an operator, in particular a pilot, in the decision taking relating to the ability of an aircraft (not represented), in particular a transport plane, to start a flight.

According to the invention, said device 1 comprises:
a set 2 of sensors A1, A2, . . . , An which are onboard the aircraft. These sensors A1, A2, . . . , An represent all the technical elements and all the systems of the aircraft which are capable of automatically generating first fault information relating to equipment of the aircraft. Within the framework of the present invention, equipment (of the aircraft) is understood to imply any onboard means liable to develop a fault and corresponding in particular to equipment proper, devices, systems, functions, etc. These first fault information can be, either raw information making it possible to deduce (in particular by combining various raw information) the existence of a fault, or information which signals a fault in a specific manner. This set 2 can in particular comprise a system, centralized or decentralized, which catalogs the whole set of system failures, equipment, functions, etc. of the aircraft;
input means 3, which comprise for example an alphanumeric keyboard and/or designating or pointing means associated with a screen and/or any other standard interface, and which allow an operator, in particular a crew member of the aircraft, to input second fault information relating to equipment of the aircraft;
means 4 which are connected by way of the links 5 and 6 respectively to said set 2 and to said input means 3 and which are capable of automatically determining, with the aid of the first fault information received from said set 2 and of the second fault information received from said input means 3, a current failure state of the aircraft. This failure state illustrates the whole set of failures existing on the aircraft's various items of equipment (systems, functions, etc.) referenced in an MEL list specified hereinafter;
a database 7 which comprises in particular a minimum list of equipment specified below;
correlation means 8 which are connected respectively by way of links 9 and 10 to said means 4 and to said database 7 and which are formed so as to carry out, before the commencement or start of a flight, an automatic correlation between the failure state (received from said means 4) and at least said minimum equipment list (received from said database 7) so as to be able to deduce therefrom:
   the ability or otherwise of the aircraft to start the flight;
   operational limitations; and
   dimensioning failures; and
presentation means 11 which are connected by way of a link 12 to said correlation means 8 and which are capable of presenting, for example on a viewing screen 13, the results of the correlation implemented by said correlation means 8, and in particular the information relating to the ability or otherwise of the aircraft to start the flight.

Within the framework of the present invention, said minimum equipment list or MEL list groups together the set of equipment indispensable to flight. This list provides for the use of an aircraft under specific conditions, with tolerances for particular non-operational items of equipment. This list complies with a minimum list of reference equipment or MMEL list (“Master Minimum Equipment List”), which relates to the type of aircraft concerned, or it is more restrictive than the latter list. In a standard manner, the minimum list of reference equipment is a list which is established by the constructor of the aircraft for a particular aircraft type, with the approval of the constructor's State, and it contains the elements, one or more of which are permitted to be non-operational at the commencement of a flight.

Thus, by virtue of the invention, the correlation means 8 carry out, before a flight, a correlation between the minimum equipment list and the failure state of the aircraft, so as to be able to deduce therefrom whether the aircraft is or is not in a fit state to start the flight. As this correlation and the presentation (by the means 11) of the results of this correlation are carried out in an automatic manner, the assistance device 1 in accordance with the invention makes it possible to greatly reduce the workload of the operator, in particular the pilot of the aircraft, in his decision taking relating to the start of the flight.

This automatic correlation can in particular be carried out because the information to be verified are stored in the database 7 (and are not simply mentioned in a paper document). The information which are stored in this database 7 and which are used by the correlation means 8 to implement the aforesaid automatic correlation comprise, in particular, the following elements:
the MEL list of the potential technical failures which are fully detailed and unambiguous; and
for each of them:
   a the wording of the failure;
   a the identifier, coded, of the failure;
   the admissible maximum duration of the failure state, even in the eventuality that an exemption relating to the MEL list is possible. It is expressed, in a standard manner, in the form of complete calendar days counting from the day after the detection of the fault, or in the form of a maximum flights number;
   the number of occurrences of the function, system, equipment, etc. subject of the potential failure;
   the minimum number of occurrences, necessary for flight under exemption of the MEL list;
   if appropriate, additional restrictive conditions. These additional restrictive conditions can consist of:
      the state of one or more given systems, functions, items of equipment etc. The characterization of this state can be defined in terms of:
         its operational state (operational or out of service);
         its functional position (valve open, closed, pump running, shut down, air flow fast, slow, etc.);
         the state of selection of its control (on, off, go, stop, air flow fast, slow etc.);
      any logical combination of the states of several systems, functions, items of equipment, etc.
      limitations of operational use: limited flight altitude or level, maximum number of passengers, toilet barred etc.; and
   if appropriate, the procedures that the flight crew must apply in the presence of such a failure.

Furthermore, the state of the aircraft, which is known by the correlation means 8, in particular on the basis of the information generated by said set 2 and said input means 3, and which allows said means 8 to carry out the aforesaid automatic correlation, can comprise in particular the following information:
fault information for each function, system, item of equipment, etc. Such fault information can be provided in several ways:
   information directly advised to the device 1 by a flight crew member (pilot or engineer) in particular with the aid of the input means 3;
   information transmitted by systems (forming part of the set 2) of the aircraft;
      by a system termed the “electronic log book” (itself filled in automatically or manually);
      by a system, centralized or decentralized, cataloging the failure state of the systems, equipment, functions, etc. of the aircraft;
the precise date and time of the failure;
the current date and time;
the number of flights performed since the declaration of the failure;
the states of systems, functions, equipment the knowledge of which is necessary. Such a state may be known in an automatic manner (transmission of the data between systems) or advised by an operator following a request and may represent:
   the operational state (operational or out of service);
   the functional position (valve open, closed, pump running, shut down, air flow fast, slow, etc.); and
   the state of selection of the control (on, off, go, stop, air flow fast, slow etc.).

Moreover, for each failure, the existence of which is identified, the correlation means 8 carry out (with the aid of appropriate means, preferably integrated) the following processing:
calculation of the ultimate MEL exemption date and/or interrogation of the number of flights performed since the appearance of the failure;
comparison with the current date (or with the permitted maximum number of flights). If the current date (or the number of flights) exceeds the limit, the information is recorded;
if appropriate for the failure concerned, request the operator (pilot), for example via the screen 13, to advise (with the aid of the input means 3) regarding certain information not perceived by the systems;
comparison of the minimum number of occurrences with the actual number of occurrences. If the requisite minimum number is greater than the actual, the information is recorded;
examination, for recording, of any restrictive conditions, having regard to the known state of the aircraft, and that required by the MEL list; and
presentation to the operator, in particular with the aid of the means 11, of the global result as obtained on the basis of the recorded information. Several cases can occur:
   if all the data input necessary for the calculation are known and if the restrictive conditions are satisfied (duration of the failure, number of occurrences, any restrictive conditions, etc.), display of the condition “Good for flight”. The device 1 can, in a variant, display the associated extract from the MEL list. If operational limitations are applicable however, a status of operational limitations is presented; and
   if the current date exceeds the limit date, or if the minimum number of occurrences is greater than the actual number, or if a restrictive condition is not fulfilled, a recommendation not to carry out the flight is presented, exhibiting the reason or reasons why, while specifying, if appropriate at the request of the operator, the associated extract from the MEL list;
   independently of the information above, if one or more of the restrictive conditions are not satisfied, the device 1 presents the recommendation not to carry out the flight with, in particular, the exhibiting of the unsatisfied condition or conditions; and
   if not all the conditions input are known (for example certain restrictive conditions), a conditional intermediate status is presented.

In a first preferred embodiment, the whole of the assistance device 1 is onboard the aircraft and therefore aids the crew, in particular the pilot (or flight captain), to take their decision relating to the start of the flight.

Furthermore, in a second embodiment, except for said set 2 of sensors A1 to An, said device 1 forms a set which is not onboard the aircraft and which is connected to said onboard sensors A1 to An by a data transmission link (for example the link 5) of standard type. In this case, this set which is not onboard is, preferably, situated on the ground, within a service of the airline which is provided for at the departure airport level and the purpose of which may, in particular, be to propose the starting off or otherwise of the aircraft, before final decision by the flight captain.

Furthermore, said device 1 comprises, moreover, interrogation means which are, for example, integrated into the correlation means 8 and which are capable of requesting an operator, in particular by displaying it on the viewing screen 13, to input particular information into said device 1, in particular with the aid of said input means 3.

In particular, the crew has the ability to advise regarding the nature of the flight involved:
ETOPS flight (twin-engine flight in accordance with particular regulations, relating in particular, to the equipment onboard so as to be able to move away from the airport as close as possible to a maximum flight duration);
flight which is scheduled to be made totally under coverage by ground radio aids (condition coming into certain MEL conditions);
flight scheduled under RVSM operations (demands highly precise vertical navigation);
flight scheduled under RNP operations (demands highly precise lateral navigation);
FANS A flight, or FANS B flight, or FANS A+ flight, etc. For each of these types of flights (comprising exchanges with the controllers through data transmission links), certain functions of the aircraft and minimum equipment are necessary;
landing scheduled under CAT I, CAT II, CAT IIIa, CAT IIIb conditions (which at one and the same time define environmental visibility conditions, and minimum conditions for the aircraft equipment).

In such a case, the device 1 takes account thereof, as a function of the various logic contained in the MEL list, in the following manner:
for each of the categories of operations stated above, the company has logged in the MEL list the conditions of carriage of functions, systems, equipment, etc.;
for each of the categories of operations stated above, and for each MEL input concerned, the company has logged in the MEL list any restrictive conditions of use in the event of failure not leading however to a recommendation not to carry out the flight; and
the restrictions stated above, when they are applicable, are taken into account in the event of any failures, by the device 1.

The crew also has the ability to advise (with the aid of the input means 3 in particular) regarding the state of certain systems, equipment, functions, etc. such as demanded by the MEL list:
state of an indicator light;
state of a valve;
result of a check.

It will be noted, moreover, that said device 1 integrates, via the MEL list, the regulatory requirements specific to the airline and/or to the flight, as a function of the countries overflown. Examples of specific regulatory provisions may be:
the minimum number of automatic pilots available;
the minimum number of HF channels;
the minimum number of VHF channels.

Furthermore, in a particular embodiment, said assistance device 1 and in particular the correlation means 8 are triggerable, and it comprises, moreover, means 14 (which are for example connected by way of a link 15 to said means 8) for triggering said device 1 in a periodic manner, for example once a day or the first flight of each day.

Additionally, in a particular embodiment, said assistance device 1 also comprises:
means (not represented) which are triggerable by an operator (for example with the aid of the means 3) and which present, when a failure is detected and they are triggered, information relating to this failure, which emanates from said minimum equipment list, thereby making it possible to aid the pilot to acquire all the information necessary to comprehend an ongoing situation; and/or
means 16 (which are for example integrated into the means 8) for establishing a synthetic state, when several failures arise, thereby allowing the operator to have a global and synthetic picture of the actual situation of the aircraft, in relation to the regulatory requirements logged in the MEL list.

This synthetic state can, in particular, comprise the following information:
if all the data input are known and if the whole set of restrictive conditions are satisfied (duration of the failures, number of occurrences, any restrictive conditions, etc.), display on the screen 13 of the condition “Overall good for flight”. The device 1 can, in a variant, display on the screen 13 the extracts from the associated MEL list. If operational restrictions are applicable, a “flight with operational restrictions” status is presented;
if the current date exceeds any one of the limit dates, or if, for at least one MEL input, the minimum number of occurrences is greater than the actual number, or if a restrictive condition is not fulfilled, a recommendation not to carry out the flight is presented on the screen 13, exhibiting the reason or reasons why, while specifying, at the request of the operator, the associated extract from the MEL list;
independently of the information above, if one or more of the restrictive conditions are not satisfied, the device 1 presents the recommendation not to carry out the flight with the exhibiting of the unsatisfied condition or conditions; and
if not all the conditions input are known (certain restrictive conditions), a “conditional flight” intermediate status is presented on the screen 13.

The device 1 in accordance with the invention, such as represented in FIG. 1, therefore makes it possible to assist an operator, and in particular the pilot of a stationary aircraft, in his decision taking relating to whether or not to commence a flight that he envisages carrying out.

Said device 1 in accordance with the invention can however also be intended to make provision in the course of a flight, taking account in particular of any failures produced during this flight, for the possibility of starting the next flight. FIG. 2 describes a particular embodiment of the assistance device 1 in accordance with the invention, which is intended for such an application.

In addition to the elements described with reference to FIG. 1, said device 1 comprises moreover, in this particular embodiment:
a set 18 of sensors B1, B2, . . . , Bi which are onboard the aircraft and which are capable of automatically generating, in flight, fault information relating to equipment of the aircraft; and
means 19 which are connected by way of a link 20 to said set 18 and which are formed so as to automatically determine, with the aid of the fault information received from said set 18, an auxiliary failure state which indicates anticipated failures, that is to say forthcoming failures.

Moreover, in this particular embodiment of FIG. 2, the correlation means 8 carry out an automatic correlation between the auxiliary failure state (received from said means 19 by way of a link 17) and the minimum equipment list (received from said database 7) so as to be able to deduce therefrom if appropriate:
the ability or otherwise of the aircraft to start the next flight; and possibly
operational limitations and dimensioning failures.

Moreover, said presentation means 11 present the results of this correlation to the operator.

Thus, by virtue of this particular embodiment of FIG. 2, the device 1 is able to alert the flight captain and/or the maintenance service of the airline that a failure is detected and rules out the next flight. This enables them to take all the necessary measures, for example make a diversion to the most appropriate maintenance base, or forewarn the destination airport of the necessity to carry out maintenance operations, this being in particular very beneficial when these operations are unwieldy and involve specific hardware.

1. A device for assisting decision taking relating to the ability of an aircraft to start a flight, said device comprising:
onboard sensors (A1 to An) capable of automatically generating first fault information relating to equipment of the aircraft;
input means (3) allowing an operator to input second fault information relating to equipment of the aircraft;
first means (4) capable of automatically determining, with the aid of said first and second fault information received, a failure state which illustrates the whole set of failures of the aircraft;
a database (7) which comprises a minimum equipment list;
correlation means (8) which carry out an automatic correlation between the failure state received from said first means (4) and at least said minimum equipment list received from said database (7) so as to be able to deduce therefrom the ability of the aircraft to start the flight; and
presentation means (11) for presenting the results of said correlation,
wherein:
it comprises moreover:
onboard auxiliary sensors (B1 to Bi) capable of automatically generating, in flight, fault information relating to equipment of the aircraft; and
second means (19) capable of automatically determining, with the aid of the fault information received from said auxiliary sensors (B1 to Bi), an auxiliary failure state which indicates anticipated failures;
said correlation means (8) carry out an automatic correlation between the auxiliary failure state received from said second means (19) and said minimum equipment list received from said database (7) so as to be able to deduce therefrom if appropriate:
the ability or otherwise of the aircraft to start a next flight;
operational limitations; and
dimensioning failures; and
said presentation means (11) present the results of this correlation.

2. The device as claimed in claim 1,
wherein it is onboard the aircraft.

3. The device as claimed in claim 1,
wherein, except for said sensors (A1 to An), said device (1) forms a set which is not onboard the aircraft and which is connected to said onboard sensors (A1 to An) by a data transmission link.

4. The device as claimed in claim 1,
wherein said correlation means (8) are formed so as to be able to deduce, moreover, if appropriate:
operational limitations; and
dimensioning failures.

5. The device as claimed in claim 1,
wherein it comprises, moreover, interrogation means capable of requesting an operator to input particular information into said device (1).

6. The device as claimed in claim 1,
wherein it comprises, moreover, means which are triggerable by an operator and which present, when a failure is detected and they are triggered, information relating to this failure, which emanates from said minimum equipment list.

7. The device as claimed in claim 1,
wherein it comprises, moreover, means (16) for establishing a synthetic state, when several failures arise, and in that said synthetic state contains one of the following items of information:
if all the data input are known and if the set of restrictive conditions are satisfied, an authorization to start a flight;
if operational restrictions are applicable, a flight status with operational restrictions;
if the current date exceeds a limit date, or if, for at least one input of the minimum equipment list, a minimum number of occurrences is greater than an actual number, or if a restrictive condition is not fulfilled, a recommendation not to carry out the flight, while exhibiting the reason for this recommendation;
independently of the previous item of information, if at least one restrictive condition is not satisfied, a recommendation not to carry out the flight with the exhibiting of the unsatisfied restrictive condition; and
if not all the conditions input are known, a conditional flight intermediate status.

8. The device as claimed in claim 1,
wherein it is triggerable, and in that it comprises means (14) for triggering said device (1) in a periodic manner.
